(19) United States
(12) Patent Application Publication
(10) Pub. No.: US 2026/0269667 A1
(43) Pub. Date: Sep. 10, 2026

(54) PERMANENT MAGNET ASSISTED WOUND FIELD MACHINE

(71) Applicant: GM Global Technology Operations LLC, Detroit, MI (US)

(72) Inventors: Alireza Fatemi, Canton, MI (US); Thomas W. Nehl, Shelby Twp., MI (US); Shawn H. Swales, Farmington, MI (US); Peng Peng, Rochester Hills, MI (US); Derek Frei Lahr, Ann Arbor, MI (US)

(73) Assignee: GM Global Technology Operations LLC, Detroit, MI (US)

(21) Appl. No.: 19/070,867

(22) Filed: Mar. 5, 2025

(51) Int. Cl. H02K 1/22; H02K 1/24

(52) U.S. Cl. CPC H02K 1/223; H02K 1/24

(57) ABSTRACT

An electric machine including a stator having a rotor cavity and a rotor disposed within the rotor cavity and rotatable about a rotational axis. The rotor includes a rotor body, one or more poles coupled to the rotor body and each having one or more pole shoes, a first source of magnetomotive force (MMF) coupled to the one or more poles of the rotor body, and a second source of MMF that provides MMF in a direction that is parallel to the MMF provided by the first source, the second source of MMF being arranged between the one or more pole shoes and the rotor body.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to electric machines and, more particularly, to a synchronous electric motor machine having a hybrid rotor excitation.

An electric motor is a device that converts electrical energy into mechanical energy by using the principle of electromagnetism. In an electric motor, an electric current is conveyed through windings in a stator, which is the stationary part of the motor, to generate a moving magnetic field. This moving magnetic field interacts with a rotor, which is the rotating part of the motor, to generate a torque that turns the rotor. The rotor is disposed within the stator and may incorporate permanent magnets or electromagnets. Electric motors may be classified as induction electric motors or synchronous electric motors, depending on how the rotor is magnetized and synchronized with the stator's magnetic field.

Magnetomotive force (MMF) is a measure of the strength of a magnetic source, such as a current-carrying coil or a permanent magnet, that produces a magnetic flux in a magnetic circuit. MMF is analogous to the electromotive force (EMF) that drives an electric current in an electric circuit. MMF is expressed in ampere-turns (AT), which is the product of the current in amperes (A) and the number of turns of the coil (N). The MMF of a coil is proportional to the magnetic field intensity (H) that it creates, and the MMF of a permanent magnet is proportional to its magnetic flux density (B) and magnetic coercivity (H_{c}). MMF is an important parameter in the design and analysis of electric motors, as it determines the amount of magnetic flux that can be generated in the air gap between the stator and the rotor and, thus, the torque that can be produced by the motor.

While electric motors achieve their intended purpose, there is a need for an improved wound field motor that has high rotor field excitation levels.

### SUMMARY

In one configuration, an electric machine is provided and includes a stator having a rotor cavity and a rotor disposed within the rotor cavity and rotatable about a rotational axis. The rotor includes a rotor body, one or more poles each having a pole body coupled to the rotor body and one or more pole shoes, a first source of magnetomotive force (MMF) coupled to the one or more poles, and a second source of MMF that provides MMF in a direction that is parallel to the MMF provided by the first source, the second source of MMF being arranged between the one or more pole shoes and the rotor body.

The electric machine may include one or more of the following optional aspects. For example, the first source of MMF is one or more electromagnets. The second source of MMF is one or more permanent magnets.

According to at least one aspect, the rotor includes one or more rotor air gaps between the one or more poles. The one or more rotor air gaps are arranged between the second source of MMF and the one or more pole shoes.

According to another aspect, a wedge is arranged in each of the one or more rotor air gaps and extends between the rotor body and the one or more pole shoes. The second source of MMF is sandwiched between the one or more pole shoes and the wedge.

According to at least one example, the wedge includes a receptacle that receives a portion of the second source of MMF. The one or more pole shoes include pole tips that overlap a portion of the second source of MMF and trap the second source of MMF between the one or more pole shoes and the receptacle. The portion of the second source of MMF exposed to the rotor air gap is based on a function including magnet size and magnetic flux density.

In another configuration, an electric machine is provided and includes a stator having an interior surface defining a rotor cavity and one or more coiled windings and a rotor disposed within the rotor cavity and rotatable about a rotational axis. The rotor includes a rotor body and one or more poles each having a pole body extending between a proximal end that is coupled to the rotor body and a distal end spaced from the proximal end. One or more pole shoes are coupled to the proximal end, the one or more poles defining rotor air gaps spaced circumferentially with respect to the rotational axis. One or more electromagnets are coupled to the rotor body of the one or more poles and extend between the proximal end and the distal end, one or more wedges are arranged in the rotor air gaps and extend between the rotor body and the pole shoes, and one or more permanent magnets are arranged between the one or more wedges and the one or more pole shoes.

The electric machine may include one or more of the following optional aspects. For example, the one or more electromagnets is a first source of magnetomotive force (MMF) and the one or more permanent magnets is a second source of MMF.

According to at least one aspect, the one or more wedges include a main body coupled to the rotor body and one or more arms extending toward the pole shoes. The one or more arms include fingers extending along the pole shoes and arranged in slots of the permanent magnets, the pole shoes including pole tips that overlap a portion of the permanent magnets. The rotor air gaps each include a first air gap defined by and arranged between the permanent magnet, the one or more arms, and the main body, and a second air gap defined by and arranged between the pole shoes and the permanent magnets.

A vehicle is provided and includes a vehicle body extending between a first end and a second end, a power reservoir coupled to the vehicle body, and an electric machine coupled to the vehicle body and communicatively coupled to the power reservoir, the electric machine including a rotor having one or more first segments including a first source of magnetomotive force (MMF) and one or more second segments coupled to the one or more first segments and including a second source of MMF that provides MMF in a direction that is parallel to the MMF provided by the first source.

The vehicle may include one or more of the following optional aspects. For example, the one or more first segments include a pole having a pole body extending between a first end and a second end and one or more pole shoes coupled to the second end. The first source of MMF is an electromagnet and is coupled to the pole body between the first end and the second end. The one or more second segments include one or more channels. The second source of MMF is one or more permanent magnets, the one or more permanent magnets being arranged in the one or more channels.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle according to principles of the present disclosure;

FIG. 2 is cross-sectional view of an electric machine having two sources of magnetomotive force (MMF) according to the principles of the present disclosure;

FIG. 3 is a detailed cross-sectional view of a portion of the electric machine of FIG. 2;

FIG. 4 is a cross-sectional view of a portion of a configuration of a rotor for an electric machine according to the principles of the present disclosure;

FIG. 5 is a detailed cross-sectional view of the rotor of FIG. 4; and

FIG. 6 is a fragmentary cross-sectional view of another configuration of a rotor for an electric machine according to the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Some of the principles of the present disclosure provide an electric machine that includes at least two sources of magnetomotive force (MMF). As will be discussed in greater detail below, arranging one or more permanent magnets with respect to electromagnets of a wound field motor can be desirable for achieving high rotor field excitation levels that are necessary for high performance motors. Some other benefits can include reducing cycle efficiency, reducing peak field losses, and reducing the overall size of the motor. Shortcomings of existing systems will also be addressed by one or more principles of the present disclosure.

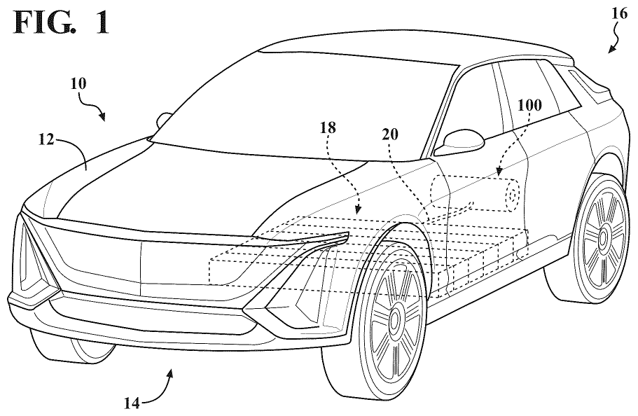

With reference to FIG. 1, an illustrative example of a vehicle 10 is provided. The vehicle 10 has a vehicle body 12 extending between a first end 14 and a second end 16. The vehicle 10 includes a power reservoir (e.g., battery pack) 18 coupled to the vehicle body 12. The power reservoir 18 is communicatively coupled to an electric machine (i.e., electric motor) 100 via a cable 20.

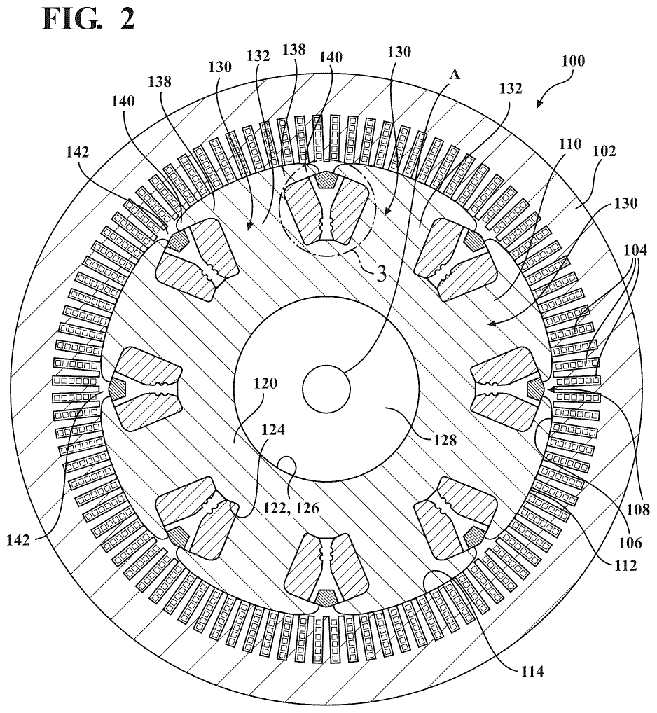

With reference to FIG. 2, an illustrative configuration of the electric machine 100 is provided. The electric machine 100 includes a stator 102 having a plurality of coiled windings 104 configured to generate a rotating magnetic field when energized with a power source, such as a three-phase electric power source. The stator 102 includes an interior surface 106 defining a rotor cavity 108. A rotor 110, rotatable about a rotational axis A, is disposed within the rotor cavity 108 of the stator 102. The rotor 110 includes an outer surface 112 spaced from the interior surface 106 of the stator 102 to define an annular air gap 114 between the rotor 110 and the stator 102. The rotor 110 includes more than one source of magnetomotive force (MMF), such as one or more electromagnets (i.e., coils, windings, etc.) 116 and one or more permanent magnets 118. The one or more permanent magnets 118 can be arranged with respect to the rotor 110 to provide additional MMF that is parallel to the MMF of the electromagnets 116, details and benefits of which are further disclosed below.

With continued reference to FIG. 2, the rotor 110 includes a rotor body 120 that includes an inner body surface 122 and an outer body surface 124. The inner body surface 122 defines a rotor body cavity 126 that is configured to receive a shaft 128. The rotor 110 can be configured with one or more salient poles. In other words, the rotor 110 includes one or more poles 130 coupled to the outer body surface 124 of the rotor body 120 and extend toward the outer surface 112 of the rotor 110. The one or more poles 130 each include a pole body 132 having a proximal end 134 coupled to or otherwise attached to the outer body surface 124 and a distal end 136 spaced from the proximal end 134. Each pole 130 includes one or more pole shoes 138 attached to the distal end 136, extending circumferentially around the rotational axis A, and terminating at pole shoe tips 140.

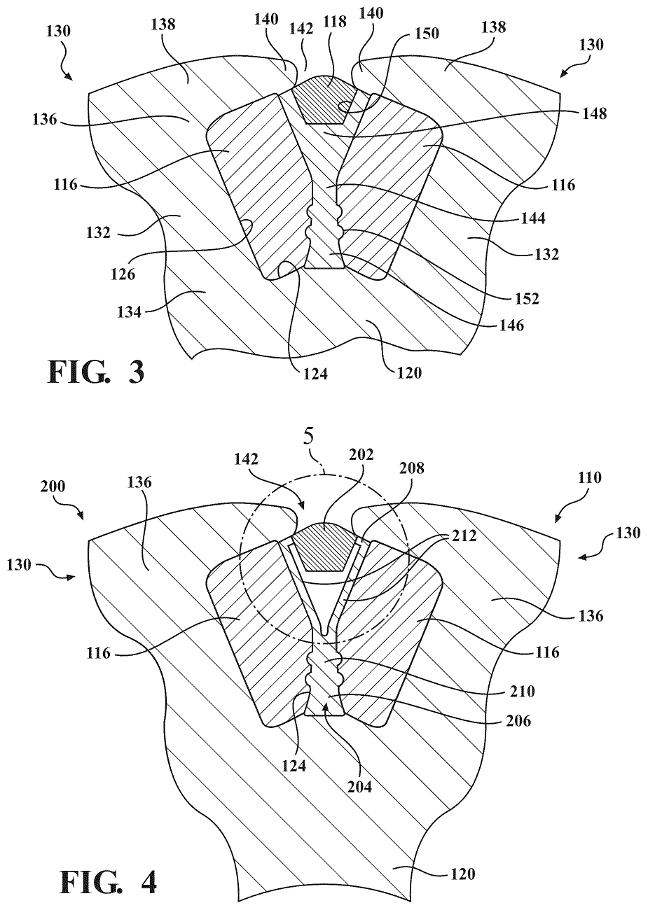

With reference to FIGS. 2 and 3, the pole bodies 132 and pole shoes 138 define rotor air gaps 142. The electromagnets 116 can be arranged on (e.g., wrapped around) each of the pole bodies 132 and extend between the proximal end 134 and the distal end 136. As shown in FIG. 3, portions of the electromagnets 116 arranged on neighboring poles 130 extend into and fill a portion of the rotor air gaps 142. The electromagnets 116 provide a first source of MMF and, as will be outlined below, the permanent magnets 118 can be arranged in rotor air gaps 142 and establish a second source of MMF that is parallel to the MMF provided by the electromagnets 116.

With reference to FIG. 3, one or more wedges 144 can be arranged in and reduce the size of the rotor air gaps 142. More particularly, each wedge 144 can include a proximal end 146 coupled to or arranged adjacent to the outer body surface 124 of the rotor body 120 and a distal end 148 arranged adjacent to the distal end 136 of the poles 130. More particularly, the distal end 148 can include a receptacle 150 that is configured to receive one of the permanent magnets 118. Each wedge 144 can also include one or more ribs 152 that are configured to retain and maintain the position of the wedge 144 with respect to opposing electromagnets 116. According to one aspect, the permanent magnets 118 are pinned or sandwiched radially between the distal end 148 of the wedge 144 and the pole shoe tips 140 of opposing pole shoes 138. In other words, the permanent magnets 118 can be loaded in compression between the distal end 148 of the wedge 144 and the pole shoes 138. According to another aspect, the permanent magnets 118 can be ring magnets, which can be desirable to reduce stress on the pole shoes 138 and, more particularly, the pole shoe tips 140.

The pole shoes 138 and, more particularly, the pole shoe tips 140 overlap a portion of the permanent magnets 118. According to one aspect, the percentage overlap can be defined at least in part by a ratio defined by magnet size, magnetic flux density, and the saturation level of the material (e.g., steel) selected for the rotor 110 and/or the stator 102. In other words, a portion of the permanent magnets 118 is exposed to the rotor air gap 142 can be determined using a function comprising the magnet size, the magnetic flux density, and the saturation level of the material for the rotor 110 and/or the stator 102. In the present illustrative configuration, the rotor air gaps 142 are reduced to regions defined by the permanent magnets 118 and the pole shoe tips 140. As such, the direction of magnetization is in the circumferential direction with respect to the axis of rotation A, which reduces the saturation of the poles 130 and provides backing to reduce a reluctance path of the permanent magnet flux.

In at least one configuration, the permanent magnets 118 can be retrofitted into a conventional wound field motor with minimal structural impact of the baseline motor.

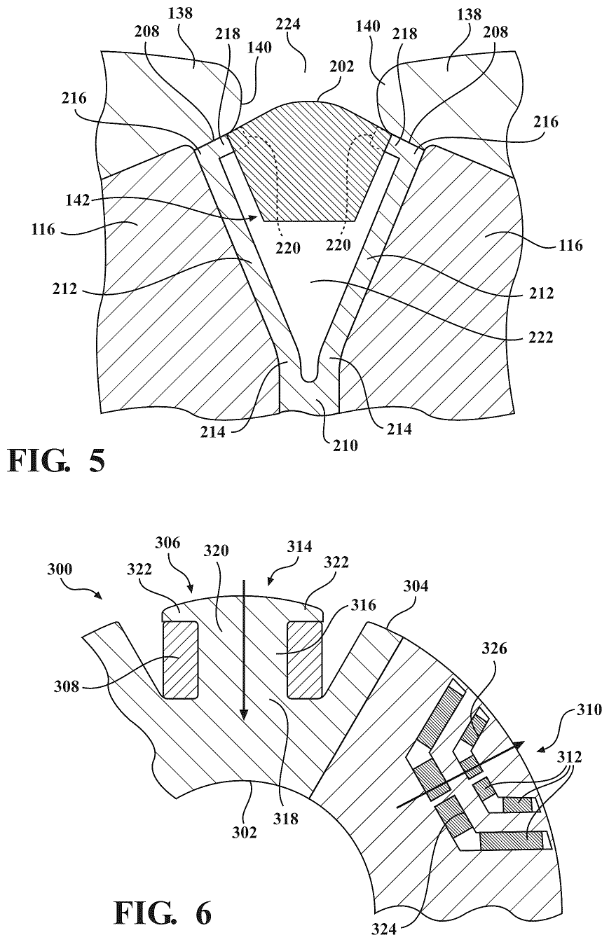

FIGS. 4 and 5 illustrate another illustrative configuration of an electric machine 200. This configuration is similar in many respects to the configuration of FIGS. 1-3. Accordingly, the descriptions of the configurations are hereby incorporated into one another, and description of subject matter common to the configurations generally may not be repeated.

In general, FIGS. 4 and 5 provide another possible configuration for arranging a permanent magnet 202 with respect to the rotor 110 and the electromagnets 116 introduced above. The electric machine 200 includes one or more wedges 204 that can be arranged in and reduce the size of the rotor air gaps 142. More particularly, each wedge 204 includes a proximal end 206 coupled to or arranged adjacent to the outer body surface 124 of the rotor body 120 and a distal end 208 arranged adjacent to the distal end 136 of the poles 130.

With reference to FIGS. 4 and 5, the wedge 204 includes a main body 210 and arms 212 that extend from the main body 210 and define at least a portion of the distal end 208. Now with reference to FIG. 5, the arms 212 each have a first end 214 coupled to the main body 210 and a second end 216 spaced from the first end 214. A portion of the arms 212 is configured to contact the electromagnets 116 between the first end 214 and the second end 216. The arms 212 also include fingers 218 that are coupled to the distal ends 208 and extend along the pole shoes 138 and toward one another. The arms 212 and the fingers 218 can be configured to pinch and/or retain the permanent magnet 202 with respect to the electromagnets 116. The permanent magnets 202 can include slots or openings 220 that are configured to receive a portion of the fingers 218, as shown in FIG. 5. Similar to the preceding configuration, the pole shoes 138 overlap and/or contact a portion of the permanent magnets 202. The percentage or amount of overlap can depend on a number of factors, such as magnet size, magnetic flux density, and/or the saturation level of the material (e.g., steel) selected for the rotor 110 and/or the stator 102 (FIG. 2), for example.

With continued reference to FIG. 5, the rotor air gap 142 includes a first or inner air gap 222 positioned between and defined by the permanent magnet 202, the arms 212, and the fingers 218. The rotor air gap 142 also includes a second or outer air gap 224 positioned between and defined by the permanent magnet 202 and the opposing pole shoes 138 and, more particularly, the pole shoe tips 140. According to one aspect, the wedge 204 suspends the permanent magnet 202 between the inner air gap 222 and the outer air gap 224.

FIG. 6 illustrates an illustrative configuration of a rotor 300 including at least two sources of MMF. This configuration is similar in many respects to the configurations of FIGS. 1-3 and FIGS. 4-5. Accordingly, the descriptions of the configurations are hereby incorporated into one another, and description of subject matter common to the configurations generally may not be repeated.

With reference to FIG. 6, the rotor 300 includes an inner surface 302 and an outer surface 304 spaced from the inner surface 302. The rotor 300 includes one or more segments that are coupled to one another to define the inner surface 302 and the outer surface 304. The one or more segments can include one or more first segments 306 that include one or more first or electromagnets 308 and one or more second segments 310 that include one or more second or permanent magnets 312. The one or more electromagnets 308 and the one or permanent magnets 312 each provided a separate MMF.

With continued reference to FIG. 6, the one or more first segments 306 each have a pole 314 that has a pole body 316 extending between a proximal end 318 and a distal end 320 spaced from the proximal end 318. The pole 314 also includes one or more pole shoes 322 coupled to and extending from the distal end 320 of the pole body 316. The electromagnet 308 can be wound (i.e., wrapped) around the pole body 316 and extend between the proximal end 318 and the distal end 320. The electromagnets 308 can be desirable to change the state of magnetization of the permanent magnets 312 and/or to augment or reduce a net rotor MMF. According to another aspect, the electromagnets 308 can be desirable for adjusting output performance and efficiency of an electric machine. For instance, the electromagnets 308 can be at maximum excitation during peak performance and can be inactive during partial load operation. Additionally, the electromagnets 308 can be configured to cancel the permanent magnet field during a field weakening operation.

With continued reference to FIG. 6, the one or more second segments 310 each have one or more channels or receptacles that are configured to receive and retain the one or more permanent magnets 312. The number and size of the one or more channels, as well as the number and size of the permanent magnets 312, can depend on the strength of the MMF of the electromagnets 308 arranged on the poles 314 of neighboring first segments 306. In the present illustrative example, the one or more channels include a first or inner channel 324 and a second or outer channel 326. The inner channel 324 and the outer channel 326 are configured to receive and retain the one or more permanent magnets 312. The permanent magnets 312 can be made of neodymium (Nd) metal or another magnetic material commonly used in the automotive industry, for example.

While the first segment 306 and the second segment 310 are separate segments in the present configuration, it is possible for the first and second segments 306, 310 to be formed as a single integral component. In either configuration, supplementing the MMF generated by the electromagnets 308 with MMF generated by the permanent magnets 312 can be desirable for reducing cycle losses and/or boost peak torque and power during operation, for example.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An electric machine, comprising:
a stator including a rotor cavity; and
a rotor disposed within the rotor cavity and rotatable about a rotational axis, the rotor comprising:
a rotor body,
one or more poles each having a pole body coupled to the rotor body and one or more pole shoes,
a first source of magnetomotive force (MMF) coupled to the one or more poles, and
a second source of MMF that provides MMF in a direction that is parallel to the MMF provided by the first source, the second source of MMF being arranged between the one or more pole shoes and the rotor body.

2. The electric machine of claim 1, wherein the first source of MMF is one or more electromagnets.

3. The electric machine of claim 2, wherein the second source of MMF is one or more permanent magnets.

4. The electric machine of claim 1, wherein the rotor includes one or more rotor air gaps between the one or more poles.

5. The electric machine of claim 4, wherein the one or more rotor air gaps are arranged between the second source of MMF and the one or more pole shoes.

6. The electric machine of claim 4, wherein a wedge is arranged in each of the one or more rotor air gaps and extends between the rotor body and the one or more pole shoes.

7. The electric machine of claim 6, wherein the second source of MMF is sandwiched between the one or more pole shoes and the wedge.

8. The electric machine of claim 6, wherein the wedge includes a receptacle that receives a portion of the second source of MMF.

9. The electric machine of claim 8, wherein the one or more pole shoes include pole tips that overlap a portion of the second source of MMF and trap the second source of MMF between the one or more pole shoes and the receptacle.

10. The electric machine of claim 9, wherein the portion of the second source of MMF exposed to the one or more rotor air gaps is a function comprising magnet size and magnetic flux density.

11. An electric machine, comprising:
a stator including an interior surface defining a rotor cavity and one or more coiled windings; and
a rotor disposed within the rotor cavity and rotatable about a rotational axis, the rotor comprising:
a rotor body,
one or more poles each having a pole body extending between a proximal end that is coupled to the rotor body and a distal end spaced from the proximal end, one or more pole shoes coupled to the proximal end, the one or more poles defining rotor air gaps spaced circumferentially with respect to the rotational axis,
one or more electromagnets coupled to the rotor body of the one or more poles and extending between the proximal end and the distal end,
one or more wedges arranged in the rotor air gaps and extending between the rotor body and the pole shoes, and
one or more permanent magnets arranged between the one or more wedges and the one or more pole shoes.

12. The electric machine of claim 11, wherein the one or more electromagnets is a first source of magnetomotive force (MMF) and the one or more permanent magnets is a second source of MMF.

13. The electric machine of claim 11, wherein the one or more wedges include a main body coupled to the rotor body and one or more arms extending toward the pole shoes.

14. The electric machine of claim 13, wherein the one or more arms include fingers extending along the pole shoes and arranged in slots of the permanent magnets, the pole shoes including pole tips that overlap a portion of the permanent magnets.

15. The electric machine of claim 14, wherein the rotor air gaps each include a first air gap defined by and arranged between the permanent magnet, the one or more arms, and the main body, and a second air gap defined by and arranged between the pole shoes and the permanent magnets.

16. A vehicle, comprising:
a vehicle body extending between a first end and a second end;
a power reservoir coupled to the vehicle body; and
an electric machine coupled to the vehicle body and communicatively coupled to the power reservoir, the electric machine comprising:
a rotor including one or more first segments including a first source of magnetomotive force (MMF) and one or more second segments coupled to the one or more first segments and including a second source of MMF that provides MMF in a direction that is parallel to the MMF provided by the first source.

17. The vehicle of claim 16, wherein the one or more first segments include a pole having a pole body extending between a first end and a second end and one or more pole shoes coupled to the second end.

18. The vehicle of claim 17, wherein the first source of MMF is an electromagnet and is coupled to the pole body between the first end and the second end.

19. The vehicle of claim 18, wherein the one or more second segments include one or more channels.

20. The vehicle of claim 19, wherein the second source of MMF is one or more permanent magnets, the one or more permanent magnets being arranged in the one or more channels.
